(19) United States
(12) Patent Application Publication
(10) Pub. No.: US 2016/0137890 A1
(43) Pub. Date: May 19, 2016

(54) COVERLAY ADHESIVE COMPOSITION

(71) Applicant: E I DU PONT DE NEMOURS AND COMPANY, Wilmington, DE (US)

(72) Inventor: TUNG LIN LI, New Taipei City (TW)

(21) Appl. No.: 14/943,456

(22) Filed: Nov. 17, 2015

Related U.S. Application Data
(60) Provisional application No. 62/081,232, filed on Nov. 18, 2014.

(51) Int. Cl. C09J 171/12; C09J 151/00

(52) U.S. Cl. CPC C09J 171/12; C09J 151/003; C08K 5/5313

(57) ABSTRACT

The present disclosure is directed to a coverlay adhesive. The coverlay adhesive contains 40 to 80 wt % maleic anhydride grafted styrene ethylene butadiene styrene copolymer having greater than 1 wt % maleic anhydride, 3 to 14 wt % epoxy resin, 0.5 to 1.5 wt % hardener, 0.05 to 0.1 wt % catalyst, 10 to 26 wt % organic flame retardant, and optionally polypheneylene ether.

### FIELD OF DISCLOSURE

This disclosure relates generally to adhesives. More specifically, the disclosure relates to coverlay adhesive compositions.

### BACKGROUND OF THE DISCLOSURE

Adhesives for coverlay or bondply materials for high frequency applications used in flexible printed circuit board (FPCB) must have low Dₖ (dielectric constant) and low D_{f} (dissipation factor or loss tangent) to address the need for high speed signal transmission with low signal loss. The industry also desires lower lamination temperatures while maintaining good peel strength, as well as good solder resistance for bondply applications.

Adhesive compositions for these applications often include epoxy and/or fluorine polymer filler particles dispersed in the resin to reduce the dielectric constant and loss in these compositions. However, the heat resistance of these adhesives is poor due the decomposition of fluorine polymer fillers at high temperature (288° C.). Resin formulations comprising poly(phenyl ether) (PPE) with vinyl functional groups, hydrogenated styrene butadiene styrene copolymer (SEBS) and epoxy/hardener to achieve low dielectric and loss tangent properties are known, however, their lamination temperatures are too high (exceeding 200° C.), which cannot meet conventional processing temperatures (180° C.).

For the forgoing reasons, a need exists for adhesive compositions having low Dₖ (dielectric constant) and low D_{f} (dissipation factor or loss tangent), good peel strength, and lower lamination temperatures.

### SUMMARY

The present disclosure is directed to a coverlay adhesive consisting essentially thereof:

I. 40 to 80 wt % maleic anhydride grafted styrene ethylene butadiene styrene copolymer having greater than 1 wt % maleic anhydride;
II. 3 to 14 wt % epoxy resin;
III. 0.5 to 1.5 wt % hardener;
IV. 0.05 to 0.1 wt % catalyst;
V. 10 to 26 wt % organic flame retardant; and
VI. optionally polypheneylene ether.

### DETAILED DESCRIPTION

### Definitions

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only to those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The present disclosure is directed to an adhesive. The adhesive is well suited for high speed high frequency applications and more particularly to a coverlay adhesive for high speed high frequency applications. Adhesives for high speed high frequency applications need to have low Dₖ (dielectric constant) and low D_{f} (dissipation factor or loss tangent) and high peel strength.

The coverlay adhesive of the present disclosure consists essentially thereof:

I. 40 to 80 wt % maleic anhydride grafted styrene ethylene butadiene styrene copolymer (MA-g-SEBS) having greater than 1 wt % maleic anhydride,
II. 3 to 14 wt % epoxy resin,
III. 0.5 to 1.5 wt % hardener,
IV. 0.05 to 0.1 wt % catalyst,
V. 10 to 26 wt % organic flame retardant, and
VI. optionally polypheneylene ether.

It has been found that maleic anhydride functionalized SEBS provides increased peel strength over unmodified SEBS and does not increase the Dₖ or D_{f} and in some embodiments desirably lowers the Dₖ and/or D_{f}. In some embodiments, the maleic anhydride grafted styrene ethylene butadiene styrene copolymer is present from 40 to 80 wt % based on the total weight of the adhesive composition. In some embodiments, the maleic anhydride grafted styrene ethylene butadiene styrene copolymer is present from 40.2 to 75.3 wt % based on the total weight of the adhesive composition. In some embodiments, the maleic anhydride grafted styrene ethylene butadiene styrene copolymer is present from 67 to 76 wt % based on the total weight of the adhesive composition. In some embodiments, the maleic anhydride grafted styrene ethylene butadiene styrene copolymer is present from 67.1 to 75.3 wt % based on the total weight of the coverlay adhesive.

In some embodiments, the maleic anhydride grafted styrene ethylene butadiene styrene copolymer has greater than 1 wt % maleic anhydride based on the total weight of the maleic anhydride grafted styrene ethylene butadiene styrene copolymer. In some embodiments, the amount of maleic anhydride is greater than 1 wt % and less than 2 wt %. In some embodiments, maleic anhydride grafted styrene ethylene butadiene styrene copolymer has greater than 1 wt % and less than 2 wt % maleic anhydride.

The coverlay adhesive composition contains an epoxy resin. Typically the epoxy resin enhances the crosslink density of the adhesive and further improves peel strength. In one embodiment of the present disclosure, the epoxy resin is present in an amount from 3 to 14 wt %. In another embodiment, the coverlay adhesive contains 3.6 to 13.7 wt % epoxy resin. In some embodiments, the epoxy resin is a bisphenol A derivative or a polyphenylene ether. In some embodiments, the bisphenol A derivative is bisphenol A carboxyl terminated butadiene acrylonitrile or bisphenol A dimer fatty acid or mixtures thereof.

When an epoxy resin is present, a hardener and catalyst are used. The epoxy and the hardener react to increase crosslink density and the catalyst is used to initiate their reaction. An increase in crosslink density may increase the heat resistance of the epoxy resin and the adhesive composition in which it is contained.

In some embodiments, the coverlay adhesive contains 0.5 to 1.5 wt % hardener. In another embodiment, the coverlay adhesive layer contains 0.5 to 1.07 wt % hardener. In some embodiments, the hardener can be any hardener capable of reacting with an epoxy resin to increase the crosslink density. In one embodiment, the hardener is a phenolic compound. In some embodiments, the phenolic compound is selected from the group consisting of:

Novolac type phenol resin,

Aralkyl type phenol resin,

Biphenyl aralkyl type phenol resin,

Multifunctional type phenol resin,

Nitrogen containing phenol resin,

Dicyclopetadiene type phenol resin,

Phosphorus containing phenol resin, and

Triazine containing phenol novolac resin.

In another embodiment, the hardener is an aromatic diamine compound. In some embodiments, the aromatic diamine compound is a diaminobiphenyl compound. In some embodiments, the diaminobiphenyl compound is 4,4′-diaminobiphenyl or 4,4′-diamino-2,2′-dimethylbiphenyl. In some embodiments, the aromatic diamine compound is a diaminodiphenylalkane compound. In some embodiments, the diaminodiphenylalkane compound is 4,4′-diaminodiphenylmethane or 4,4′-diaminodiphenylethane. In some embodiments, the aromatic diamine compound is a diaminodiphenyl ether compound. In some embodiments, the diaminodiphenyl ether compounds is 4,4′-diaminodiphenylether or di(4-amino-3-ethylphenyl)ether. In some embodiments, the aromatic diamine compound is a diaminodiphenyl thioether compound. In some embodiments, the diaminodiphenyl thioether compound is 4,4′-diaminodiphenyl thioether or di(4-amino-3-propylphenyl)thioether. In some embodiments, the aromatic diamine compound is a diaminodiphenyl sulfone compound. In some embodiments, the diaminodiphenyl sulfone compound is 4,4′-diaminodiphenyl sulfone or di(4-amino-3-isopropylphenyl)sulfone. In some embodiments, the aromatic diamine compound is phenylenediamine. In one embodiment, the hardener is an amine compound. In some embodiments, the amine compound is a guanidine. In some embodiments, the guanidine is dicyandiamide (DICY). In another embodiment, the amine compound is an aliphatic diamine. In some embodiments, the aliphatic diamine is ethylenediamine or diethylenediamine. In some embodiments, a mixture of hardeners is used. In some embodiments, the hardener is a phenol novolac. In some embodiments, the hardener is a mixture of phenol novolacs. In some embodiments, the hardener is an active ester compound.

In some embodiments, the coverlay adhesive contains 0.05 to 0.1 wt % catalyst. In another embodiment, the coverlay adhesive contains 0.056 to 0.098 wt % catalyst. In some embodiments the catalyst is any catalyst capable of initiating a reaction between an epoxy resin and hardener. In some embodiments, the catalyst is selected from the group consisting of imidazole type, triazine type, 2-ethyl-4-methyl-imidazole, triazine containing phenol novolac type and mixtures thereof. In some embodiments, the catalyst is 2-ethyl-4-methyl-1h-imidazole-1-propanenitrile.

In some embodiments, the coverlay adhesive contains 10 to 26 wt % organic flame retardant. In another embodiment, the coverlay adhesive contains 10.1 to 25.8 wt % organic flame retardant. In some embodiments, the organic flame retardant is an organophosphorus salt.

The coverlay adhesive of the present disclosure may optionally contain a polyphenylene ether. The polyphenylene ether may be present in an amount of from zero to about 40 wt %. In some embodiments, the coverlay adhesive does not contain any polyphenylene ether. In accordance with the present disclosure it was discovered that maleic anhydride grafted styrene ethylene butadiene styrene copolymer in combination with epoxy resin hardener, catalyst and flame retardant provide a coverlay adhesive that had good peel strength as well as low Dₖ and D_{f}. The low Dₖ and low D_{f} make the coverlay adhesive suitable for high speed high frequency applications.

In one embodiment, the coverlay adhesive of the present disclosure consists essentially thereof:

I. 40 to 80 wt % maleic anhydride grafted styrene ethylene butadiene styrene copolymer (MA-g-SEBS) having greater than 1 wt % maleic anhydride,
II. 3 to 14 wt % epoxy resin,
III. 0.5 to 1.5 wt % hardener,
IV. 0.05 to 0.1 wt % catalyst,
V. 10 to 26 wt % organic flame retardant, and
VI. optionally polypheneylene ether.

In one embodiment, the high speed high frequency coverlay adhesive of the present disclosure consists essentially thereof:

I. 40 to 80 wt % maleic anhydride grafted styrene ethylene butadiene styrene copolymer (MA-g-SEBS) having greater than 1 wt % and less than 2 wt % maleic anhydride,
II. 3 to 14 wt % epoxy resin,
III. 0.5 to 1.5 wt % hardener,
IV. 0.05 to 0.1 wt % catalyst,
V. 10 to 26 wt % organic flame retardant, and
VI. optionally polypheneylene ether.

In another embodiment, the coverlay adhesive of the present disclosure consists essentially thereof:

I. 40 to 80 wt % maleic anhydride grafted styrene ethylene butadiene styrene copolymer (MA-g-SEBS) having greater than 1 wt % maleic anhydride,
II. 3 to 14 wt % bisphenol A derivative or a polyphenylene ether,
III. 0.5 to 1.5 wt % hardener,
IV. 0.05 to 0.1 wt % catalyst,
V. 10 to 26 wt % organic flame retardant, and
VI. optionally polypheneylene ether.

In another embodiment, the coverlay adhesive of the present disclosure consists essentially thereof:

I. 40 to 80 wt % maleic anhydride grafted styrene ethylene butadiene styrene copolymer (MA-g-SEBS) having greater than 1 wt % maleic anhydride,
II. 3 to 14 wt % bisphenol A derivative or a polyphenylene ether,
III. 0.5 to 1.5 wt % phenol novolac,
IV. 0.05 to 0.1 wt % 2-ethyl-4-methyl-1h-imidazole-1-propanenitrile,
V. 10 to 26 wt % organic flame retardant, and
VI. optionally polypheneylene ether.

In another embodiment, the coverlay adhesive of the present disclosure consists essentially thereof:

I. 40 to 80 wt % maleic anhydride grafted styrene ethylene butadiene styrene copolymer (MA-g-SEBS) having greater than 1 wt % maleic anhydride,
II. 3 to 14 wt % bisphenol A derivative or a polyphenylene ether,
III. 0.5 to 1.5 wt % phenol novolac,
IV. 0.05 to 0.1 wt % 2-ethyl-4-methyl-1h-imidazole-1-propanenitrile,
V. 10 to 26 wt % organophosphorus salt, and
VI. optionally polypheneylene ether.

In another embodiment, the coverlay adhesive of the present disclosure consists essentially thereof:

I. 67 to 76 wt % maleic anhydride grafted styrene ethylene butadiene styrene copolymer (MA-g-SEBS) having greater than 1 wt % maleic anhydride,
II. 6 to 14 wt % epoxy resin,
III. 0.7 to 1.07 wt % hardener,
IV. 0.094 to 0.98 wt % catalyst, and
V. 10 to 26 wt % organic flame retardant.

In another embodiment, the coverlay adhesive of the present disclosure consists essentially thereof:

I. 67 to 76 wt % maleic anhydride grafted styrene ethylene butadiene styrene copolymer (MA-g-SEBS) having greater than 1 wt % and less than 2 wt % maleic anhydride,
II. 6 to 14 wt % epoxy resin,
III. 0.7 to 1.07 wt % hardener,
IV. 0.094 to 0.98 wt % catalyst, and
V. 10 to 26 wt % organic flame retardant.

In another embodiment, the coverlay adhesive of the present disclosure consists essentially thereof:

I. 67 to 76 wt % maleic anhydride grafted styrene ethylene butadiene styrene copolymer (MA-g-SEBS) having greater than 1 wt % and less than 2 wt % maleic anhydride,
II. 6 to 14 wt % bisphenol A derivative or a polyphenylene ether,
III. 0.7 to 1.07 wt % hardener,
IV. 0.094 to 0.98 wt % catalyst, and
V. 10 to 26 wt % organic flame retardant.

In yet another embodiment, the coverlay adhesive of the present disclosure consists essentially thereof:

I. 67 to 76 wt % maleic anhydride grafted styrene ethylene butadiene styrene copolymer (MA-g-SEBS) having greater than 1 wt % and less than 2 wt % maleic anhydride,
II. 6 to 14 wt % bisphenol A derivative or a polyphenylene ether,
III. 0.7 to 1.07 wt % phenol novolac,
IV. 0.094 to 0.98 wt % 2-ethyl-4-methyl-1h-imidazole-1-propanenitrile, and
V. 10 to 26 wt % organic flame retardant.

In yet another embodiment, the coverlay adhesive of the present disclosure consists essentially thereof:

I. 67 to 76 wt % maleic anhydride grafted styrene ethylene butadiene styrene copolymer (MA-g-SEBS) having greater than 1 wt % and less than 2 wt % maleic anhydride,
II. 6 to 14 wt % bisphenol A derivative or a polyphenylene ether,
III. 0.7 to 1.07 wt % phenol novolac,
IV. 0.094 to 0.98 wt % 2-ethyl-4-methyl-1h-imidazole-1-propanenitrile, and
V. 10 to 26 wt % organophosphorus salt.

An adhesive solution can be prepared by mixing each coverlay adhesive components and solvent in any order at appropriate concentration for coating on to a coverlay. After a homogeneous solution without precipitate is obtained, the adhesive solution is coated onto a coverlay, typically a polyimide coverlay. For the purpose of this disclosure, the polyimide coverlay used is Kapton® 50ENS (polyimide film available from DuPont-Toray Co., Ltd., Japan).

In some embodiments, suitable solvents are methyl ethyl ketone (MEK), toluene or mixture thereof. Routine experimentation may identify other suitable solvents for homogeneous solution of coverlay adhesive components of the present disclosure.

Coating methods include, but are not limited to, spray coating, curtain coating, knife over roll, air knife, extrusion/slot die, gravure, reverse gravure, offset gravure, roll coating, and dip/immersion. In some embodiments board coating may be used.

After coating, the adhesive coated coverlay is put into a 120° C. oven for 5 minutes to evaporate the solvent. The temperature and length of time in the oven will depend on the solvent used and thickness of the adhesive. The thickness of the coverlay adhesive can be controlled in accordance with the coating method used. For example, board coating can control the thickness of the coverlay adhesive by adjusting the gap of the coating fixture. In some embodiments, the thickness of the coverlay adhesive is from 10 to 60 microns. In another embodiment, the thickness of the coverlay adhesive is from 10 to 30 microns.

Conventional methods can be used, such as lamination, to apply the adhesive coated coverlay to copper foil, flexible printed circuit boards, electronic components, leadframes of integrated circuit packages and the like.

One advantage of the coverlay adhesive of the present disclosure is good peel strength and in some embodiments increases peel strength over conventional adhesives having SEBS. The coverlay adhesive has a peel strength of at least 0.50 N/mm when laminated to copper foil at 180° C. for 120 seconds. In some embodiments, the coverlay adhesive has a peel strength of 0.50 to 0.70 N/mm when laminated to copper foil at 180° C. for 120 seconds. The copper foil can be any commercial available copper foil. The copper foil is typically, but not limited to, rolled annealed (RA) copper foil (½ oz).

Another advantage of the coverlay adhesive of the present disclosure is the Dₖ and D_{f} are sufficiently low enough to enable the coverlay adhesive to be used in high speed high frequency (1 to 20 GHz) applications. The coverlay adhesive of the present disclosure has a dielectric constant from 2.6 to 3.0 at 10 GHz and a dissipation factor from 0.0060 to 0.0080 at 10 GHz. In another embodiment, the coverlay adhesive of the present disclosure has a dielectric constant from 2.7 to 2.84 at 10 GHz and a dissipation factor from 0.0063 to 0.0076 at 10 GHz.

The coverlay adhesive may contain additional fillers. In some embodiments, the coverlay adhesive contains dielectric filler or mixtures of dielectric fillers. Examples of useful dielectric fillers are, but are not limited to, aluminum oxide, silica, calcium carbonate, magnesium carbonate, magnesium calcium carbonate, calcium oxide, magnesium oxide, talc, magnesium silicates, aluminum silicates, magnesium aluminum silicates, calcium silicates, clay, mica, barium sulfate, boron nitride, aluminum nitride, barium titanate, strontium titanate, alumina trihydrate and calcium sulphate.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. Numerical values are to be understood to have the precision of the number of significant figures provided. For example, the number 1 shall be understood to encompass a range from 0.5 to 1.4, whereas the number 1.0 shall be understood to encompass a range from 0.95 to 1.04, including the end points of the stated ranges. It is not intended that the scope of the invention be limited to the specific values recited when defining a range.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers, unless the context indicates or implies otherwise.

The materials, methods, and examples herein are illustrative only and, except as specifically stated, are not intended to be limiting. Although methods and materials similar or equivalent to those described herein can be used, suitable methods and materials are described herein.

### EXAMPLES

The invention will be further described in the following examples, which is not intended to limit the scope of the invention described in the claims. The materials, methods, and examples herein are illustrative only and, except as specifically stated, are not intended to be limiting. Although methods and materials similar or equivalent to those described herein can be used in the practice or testing of the present invention, suitable methods and materials are described herein.

Adhesive solution was prepared by mixing each ingredient with solvent at an appropriate concentration. After a homogeneous solution was obtained (without any precipitate), it was applied onto Kapton® 50ENS (polyimide film available from DuPont-Toray, thickness of 12.5 microns) and was put into a 120° C. oven for 5 minutes to evaporate the solvent. Coverlay samples were prepared having an adhesive thickness of 20 microns for peel strength measurements and 50 microns for dielectric measurements.

Peel strength was measured with an AG1 Universal Testing Machine (Shimadzu Corp., Japan), following a 180 degree peel test method. Samples were prepared with the thinner coverlay and copper foil as follows: the coverlay was laminated to the shiny side of RA copper foil (½ oz, JX-Nippon Mining & Metals Corp., Japan) with a quick lamination machine at 180° C. for 120 seconds. After that, the sample was placed into an oven at 180° C. for 1 hr. Multiple specimens were prepared with a size of 1 mm width and 8 cm length. The average of 5-10 individual measurements was recorded.

Dielectric properties (Dₖ and D_{f}) were measured using an Agilent PNA Network Analyzer with installed 85071E software and a resonance cavity frequency of 10 GHz. Samples for dielectric measurement were prepared with the thicker coverlay by heating in an oven at 180° C. for 1 hr before testing. The individual sample size was 8 cm by 10 cm. The average of 2-3 individual measurements was recorded.

Examples 1-6 and Comparative Examples 1-3 demonstrate that adhesives having SEBS/epoxy systems, with and without maleic anhydride grafted SEBS can achieve desirable dielectric properties for coverlay adhesive applications. The peel strength of coverlay adhesives containing MA-g-SEBS, however, is superior to that of adhesives containing unmodified SEBS in these systems.

### Example 1

An adhesive solution was prepared, consisting of 40.2 wt % polyphenylene ether (OPE-2st 1200 available from Mitsubishi Gas Chemical Co., Inc., Japan), 40.2 wt % MA-g-SEBS (Taipol SEBS 7131, containing 1.38 wt % maleic anhydride, available from Taiwan Synthetic Rubber Corp. (TSRC), Taiwan), 3.6 wt % epoxy (LYF 5101, a poly(phenyl ether) epoxy available from Li Yung Far Technology Co., Ltd., Taiwan), 0.6 wt % hardener (BRG-557 a phenol novolac available from Showa Denko K.K., Japan), 0.056 wt % catalyst (2E4MI-CN (2-ethyl-4-methyl-1h-imidazole-1-propanenitrile) available from Sigma-Aldrich Co., St. Louis, Mo.), 15.4 wt % organophosphorus salt flame retardant (Exolit® OP 935 available from Clariant SE, Switzerland) and toluene as solvent. The above components can be added in any order. The solution was mixed by mechanical stirring until a homogeneous solution without precipitate was obtained. The solution was then coated on a 0.5 mil (12.5 micron) Kapton® 50ENS polyimide film using a board coater (Coatmaster 509MC, Erichsen GmbH & Co. KG, Germany). After that, the coated film was placed into a 120° C. oven for 5 minutes to eliminate the solvent.

Peel strength measurement and sample preparation are described above.

For Dₖ and D_{f} measurements, adhesive thickness was controlled at 50 microns on Kapton® 50ENS. Sample preparation and measurement are described above.

Results are shown in Table 1.

### Comparative Example 1

An adhesive solution was prepared, consisting of 40.2 wt % PPE (OPE-2st 1200), 40.2 wt % SEBS (Taipol SEBS 6152 available from TSRC), 3.6 wt % epoxy (LYF 5101), 0.6 wt % hardener (BRG-557), 0.056 wt % catalyst (2E4MI-CN), 15.4 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Example 2

An adhesive solution was prepared, consisting of 40.3 wt % PPE (OPE-2st 1200), 40.3 wt % MA-g-SEBS (Taipol SEBS 7131), 3.6 wt % epoxy (LYF 5102, a poly(phenyl ether) epoxy available from Li Yung Far Technology), 0.6 wt % hardener (BRG-557), 0.056 wt % catalyst (2E4MI-CN), 15.5 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Comparative Example 2

An adhesive solution was prepared, consisting of 40.3 wt % PPE (OPE-2st 1200), 40.3 wt % SEBS (Taipol SEBS 6152), 3.6 wt % epoxy (LYF 5102), 0.6 wt % hardener (BRG-557), 0.056 wt % catalyst (2E4MI-CN), 15.5 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Example 3

An adhesive solution was prepared, consisting of 40.3 wt % PPE (OPE-2st 1200), 40.3 wt % MA-g-SEBS (Taipol SEBS 7131), 3.6 wt % epoxy (HyPox™ DA323 bisphenol A dimer fatty acid available from CVC Thermoset Specialties, Moorestown, N.J.), 0.6 wt % hardener (BRG-557), 0.056 wt % catalyst (2E4MI-CN), 15.5 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Comparative Example 3

An adhesive solution was prepared, consisting of 40.3 wt % PPE (OPE-2st 1200), 40.3 wt % SEBS (Taipol SEBS 6152), 3.6 wt % epoxy (HyPox™ DA323), 0.6 wt % hardener (BRG-557), 0.056 wt % catalyst (2E4MI-CN), 15.5 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Example 4

An adhesive solution was prepared, consisting of 67.1 wt % MA-g-SEBS (Taipol SEBS 7131), 6.0 wt % epoxy (LYF 5101), 1.01 wt % hardener (BRG-557), 0.094 wt % catalyst (2E4MI-CN), 25.8 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Example 5

An adhesive solution was prepared, consisting of 75.3 wt % MA-g-SEBS (Taipol SEBS 7131), 13.7 wt % epoxy (HyPox™ RK84L bisphenol A carboxyl terminated butadiene acrylonitrile, available from CVC Thermoset Specialties), 0.7 wt % hardener (BRG-557), 0.098 wt % catalyst (2E4MI-CN), 10.2 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

### Example 6

An adhesive solution was prepared, consisting of 75 wt % MA-g-SEBS (Taipol SEBS 7131), 13.7 wt % epoxy (HyPox™ DA323), 1.07 wt % hardener (BRG-557), 0.098 wt % catalyst (2E4MI-CN), 10.1 wt % flame retardant (Exolit® OP 935) and toluene as solvent. The above components can be added in any order. The solution was mixed, coated on polyimide film and dried following the procedure of Example 1.

Peel strength, Dₖ and D_{f} test methods are the same as Example 1.

Results are shown in Table 1.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. All features disclosed in this specification may be replaced by alternative features serving the same, equivalent or similar purpose.

Accordingly, the specification is to be regarded in an illustrative rather than a restrictive sense and all such modifications are intended to be included within the scope of the invention.

TABLE 1

| | | | | | | | wt % | Peel | | |
|---|---|---|---|---|---|---|---|---|---|---|
| | wt % | wt % | wt % | wt % | wt % | wt % | flame | Strength | Dₖ | D_{f} |
| | PPE | SEBS | MA-g-SEBS | epoxy | hardener | catalyst | retardant | (N/mm) | (@10 GHz) | (@10 GHz) |
| Example 1 | 40.2 | — | 40.2 | 3.6 | 0.6 | 0.056 | 15.4 | 0.52 | 2.82 | 0.0063 |
| Comp. Ex 1 | 40.2 | 40.2 | — | 3.6 | 0.6 | 0.056 | 15.4 | 0.48 | 2.76 | 0.0058 |
| Example 2 | 40.3 | — | 40.3 | 3.6 | 0.6 | 0.056 | 15.5 | 0.67 | 2.84 | 0.0070 |
| Comp. Ex 2 | 40.3 | 40.3 | — | 3.6 | 0.6 | 0.056 | 15.5 | 0.24 | 2.89 | 0.0054 |
| Example 3 | 40.3 | — | 40.3 | 3.6 | 0.6 | 0.056 | 15.5 | 0.54 | 2.8 | 0.0073 |
| Comp. Ex 3 | 40.3 | 40.3 | — | 3.6 | 0.6 | 0.056 | 15.5 | 0.33 | 2.77 | 0.0064 |
| Example 4 | — | — | 67.1 | 6 | 1.01 | 0.094 | 25.8 | 0.67 | 2.78 | 0.0065 |
| Example 5 | — | — | 75.3 | 13.7 | 0.7 | 0.098 | 10.2 | 0.68 | 2.7 | 0.0071 |
| Example 6 | — | — | 75 | 13.7 | 1.07 | 0.098 | 10.1 | 0.54 | 2.74 | 0.0076 |

What is claimed is:

1. A coverlay adhesive consisting essentially thereof:
I. 40 to 80 wt % maleic anhydride grafted styrene ethylene butadiene styrene copolymer having greater than 1 wt % maleic anhydride;
II. 3 to 14 wt % epoxy resin;
III. 0.5 to 1.5 wt % hardener;
IV. 0.05 to 0.1 wt % catalyst;
V. 10 to 26 wt % organic flame retardant; and
VI. optionally polypheneylene ether.

2. The coverlay adhesive in accordance with claim 1 wherein said maleic anhydride grafted styrene ethylene butadiene styrene copolymer has greater than 1 wt % and less than 2 wt % maleic anhydride.

3. The coverlay adhesive in accordance with claim 1 wherein the epoxy resin is a bisphenol A derivative or a polyphenylene ether.

4. The coverlay adhesive in accordance with claim 3 wherein the bisphenol A derivative is bisphenol A carboxyl terminated butadiene acrylonitrile or bisphenol A dimer fatty acid or mixtures thereof.

5. The coverlay adhesive in accordance with claim 1 wherein the hardener is a phenol novolac and the catalyst is 2-ethyl-4-methyl-1h-imidazole-1-propanenitrile.

6. The coverlay adhesive in accordance with claim 1 wherein the organic flame retardant is an organophosphorus salt.

7. The coverlay adhesive in accordance with claim 1 having a peel strength of at least 0.50 N/mm when laminated to copper foil at 180° C. for 120 seconds.

8. The coverlay adhesive in accordance with claim 1 having a peel strength of 0.50 to 0.70 N/mm when laminated to copper foil at 180° C. for 120 seconds.

9. The coverlay adhesive in accordance with claim 1 having a dielectric constant from 2.6 to 3.0 at 10 GHz and a dissipation factor from 0.0060 to 0.0080 at 10 GHz.
